(19) United States
(12) Patent Application Publication
(10) Pub. No.: US 2008/0044713 A1
(43) Pub. Date: Feb. 21, 2008

(54) Fuel cell stack

(75) Inventors: Wolfgang Fritz, Metzingen (DE); Uwe Maier, Reutlingen (DE)

Correspondence Address: Mr. Edward J. Timmer, P.O. Box 770, Richland, MI, 49083-0770, US

(73) Assignee: ElringKlinger AG

(21) Appl. No.: 11/787,766

(22) Filed: Apr. 18, 2007

(30) Foreign Application Priority Data
Jun. 21, 2006 (DE) 10 2006 028 439.9

(51) Int. Cl. H01M 8/04

(52) U.S. Cl. 429/36

(57) ABSTRACT

In order to produce a fuel cell stack which comprises a plurality of fuel cell units that succeed one another in the direction of the stack and at least one tensioning device by means of which the fuel cell units are braced against each other such that tensioning forces can be introduced into the stack of fuel cell units in a particularly effective manner, it is proposed that the tensioning device should comprise at least one tensioning element in the form of a strip or tape which transmits a tensional force for the tensioning of the fuel cell units and extends around at least one end face of the fuel cell stack.

The present disclosure relates to the subject matter disclosed in the German patent application No. 10 2006 028 439.9 dated 21 Jun. 2006. The entire description of this earlier application is incorporated by reference thereto as a constituent part of the present description (“incorporation by reference”).

The present invention relates to a fuel cell stack comprising a plurality of fuel cell units that succeed one another in the direction of the stack and at least one tensioning device by means of which the fuel cell units are braced against each other.

Such a fuel cell stack is known from the DE 100 44 703 A1 for example.

In known fuel cell stacks of this type, the tensioning device comprises a plurality of tie rods by means of which solid end plates of the fuel cell stack are pulled against one another in order to apply the sealing and contacting forces to the fuel cell units that are required during the operation of the fuel cell stack.

From DE 10 2004 037 678 A1, it is known to implement the tensioning elements by means of which the end plates of a fuel cell stack are braced against each other in the form of a bar, rope, wire, chain, tape or fibre material.

The object of the present invention is to produce a fuel cell stack of the type mentioned hereinabove which enables the tensioning forces to be introduced into the stack of fuel cell units in a particularly effective manner.

In accordance with the invention, this object is achieved in the case of a fuel cell stack including the features indicated in the preamble of claim 1 in that the tensioning device comprises at least one tensioning element in the form of a strip or tape which transmits a tensional force for the tensioning of the fuel cell units and extends around at least one end face of the fuel cell stack.

Due to the fact that the tensioning element in the form of a strip or tape extends around an end face of the fuel cell stack, the tensioning forces can be introduced into the fuel cell units by the tensioning element via the relevant end face of the fuel cell stack such that they are evenly distributed over a large surface area. In consequence, a better distribution of the force can be achieved than in the case of tensioning means which only engage with the edge of the end plates of the fuel cell stack.

Furthermore, the tensioning element in the form of a strip or tape is very light in weight and only needs a small amount of space. Furthermore, such tensioning elements in the form of a strip or tape are quick and easy to install and economical to produce.

The fuel cell stack in accordance with the invention may comprise high temperature fuel cell units (of the SOFC (Solid Oxide Fuel Cell) type for example) or else low temperature fuel cell units (of the PEM (Polymer Electrolyte Membrane)—type or of the DMFC (Direct Methanol Fuel Cell) type for example).

The tensioning device comprising at least one tensioning element in the form of a strip or tape preferably serves for applying the requisite sealing and contacting forces during operation of the fuel cell stack, but it may merely serve as a means for securing the stack during the transportation thereof (in the latter case, the tensioning device can be removed prior to operating the fuel cell stack).

In a preferred embodiment of the invention, provision is made for the tensioning device to comprise at least two tensioning elements in the form of a strip or tape which extend around at least one end face of the fuel cell stack and are mutually spaced in a direction running transverse to the direction of the stack.

The fuel cell stack may comprise at least one stack end element which forms an end face boundary for the fuel cell stack.

Such a stack end element may, in particular, be in the form of an end plate.

Preferably in this case, at least one tensioning element extends around at least one stack end element of the fuel cell stack.

It is expedient hereby, if at least one tensioning element rests on at least one stack end element especially in a substantially flat manner in order to ensure a good introduction of forces into the stack end element by the tensioning element.

The tape or strip-type tensioning element used is preferably flexible so that it can conform to a stack end element of any arbitrary shape.

In order apply tension to the tensioning element, provision may be made for the tensioning element to be fixed to at least one stack end element.

Hereby for example, the tensioning element may be fixed to the stack end element in cohesive manner and/or by means of at least one fixing means, in particular, by means of at least one screw member.

In order to enable the fuel cell stack to be easily disassembled for repair and maintenance purposes, it is expedient if the tensioning element is fixed to at least one stack end element in releasable manner.

A particularly simple method of fixing the tensioning element to the stack end element especially without the use of additional fixing means and without using additional tools is obtained if the tensioning element is hooked onto the stack end element.

Such a process of hooking the tensioning element on the stack end element may be carried out in a particularly simple manner if the stack end element comprises at least one hooking nose for the purposes of hooking the tensioning element.

Furthermore, it is expedient if the tensioning element comprises at least one hooking opening for the purposes of hooking on the stack end element.

For the purposes of producing the tension in the tensioning element, provision may be made for at least one of the end regions of at least one tensioning element to be fixed to another end region of the same tensioning element or to another tensioning element.

Thus, in particular, the tensioning element may be in the form of a closed ring.

In particular, the end region of at least one tensioning element may be connected to another end region of the same tensioning element or to another tensioning element in positive manner.

This connection may be in the form of a crimped connection for example.

A particularly simple positive connection between two end regions of the same tensioning element or between end regions of different tensioning elements is obtained if at least one section of one end region of at least one tensioning element is pushed through a passage opening in another end region of the same tensioning element or in another tensioning element and is subsequently so deformed that the pushed-through section can no longer return through the passage opening.

As an alternative or in addition thereto, provision may be made for an end region of at least one tensioning element to comprise at least one passage opening and for a section of another end region of the same tensioning element or a section of another tensioning element to be pushed through this passage opening and subsequently to be so deformed that the pushed-through section can no longer return through the passage opening.

Furthermore, for the purposes of producing the necessary tension in the tensioning element, provision may be made for at least one end region of at least one tensioning element to be fixed to another end region of the same tensioning element or to another tensioning element by means of a fixing device.

Such a fixing device may comprise at least one fixing means.

Preferably, the fixing device comprises at least two mutually spaced fixing means running in a direction transverse to the direction of the stack.

Hereby, the at least one fixing means may be in the form of a fixing screw member.

Furthermore, the fixing device may comprise at least one fixing strip which is engaged by at least one fixing means.

Furthermore, the fixing device may comprise at least one seating strip through which at least one fixing means extends.

Furthermore, in a particularly preferred embodiment of the invention, the fixing device comprises at least one spring element which biases an end region of at least one tensioning element against another end region of the same tensioning element or against an end region of another tensioning element.

In the event of a change in temperature, the fuel cell units on the one hand and the material of the tensioning element on the other may expand by different amounts in the direction of the stack due to their differing average coefficients of thermal expansion. In order to provide compensation for such differences in thermal expansion, it is of advantage if the tensioning device comprises at least one resilient longitudinal expansion compensating element.

It is particularly expedient, if the longitudinal expansion compensating element is integrated into at least one tensioning element since the number of components required for the construction of the fuel cell stack can be reduced in this way.

The tensioning element is preferably formed in one piece with the longitudinal expansion compensating element.

In particular, provision may be made for at least one longitudinal expansion compensating element to be formed by a corrugated and/or folded region of at least one tensioning element.

As an alternative or in addition thereto, provision may be made for at least one longitudinal expansion compensating element to be formed by a region of at least one tensioning element that is provided with a deformable recess

In order to enable the flow of force between the fuel cell units on the one hand and the tensioning element on the other to be controlled more precisely and equalised, it is of advantage if the fuel cell stack comprises at least one resilient pressure transmission element.

Such a pressure transmission element may be arranged, in particular, between a fuel cell unit and a stack end element which forms an end face boundary for the fuel cell stack.

In order to enable the fuel cell units to be operated at an operating temperature that is significantly above the ambient temperature especially when using high temperature fuel cell units of the SOFC (Solid Oxide Fuel Cell) type for example, it is of advantage if the fuel cell stack comprises at least one thermal insulation element.

Such a thermal insulation element may be arranged, in particular, between the fuel cell units and at least one tensioning element. In this case, it is not necessary for the tensioning element to be mechanically and chemically stable at the operating temperature of the fuel cell units.

In order to enable force to be introduced into the fuel cell units in a uniform manner over a large surface area, it is particularly expedient, if the tensioning device comprises at least one tensioning element in the form of a strip or tape which extends around both of the end faces of the fuel cell stack.

Preferably in this case, the tensioning element is in the form of a closed ring.

Further features and advantages of the invention form the subject matter of the following description and the pictorial illustration of exemplary embodiments.

In the drawings:

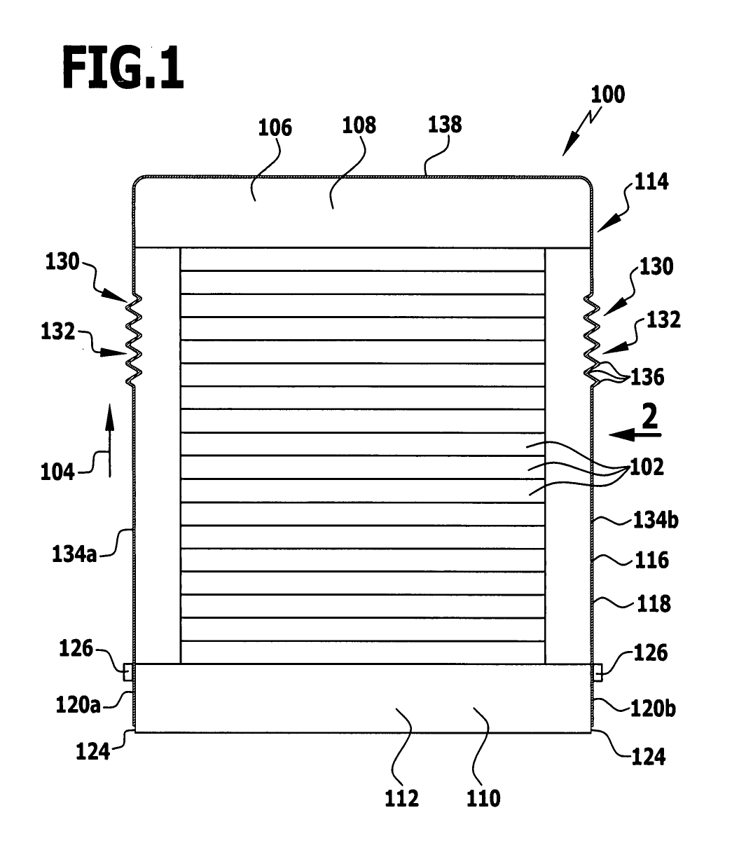

FIG. 1 shows a schematic front view of a fuel cell stack including two end plates and two tensioning tapes which are led around one of the end plates and hooked onto the second end plate;

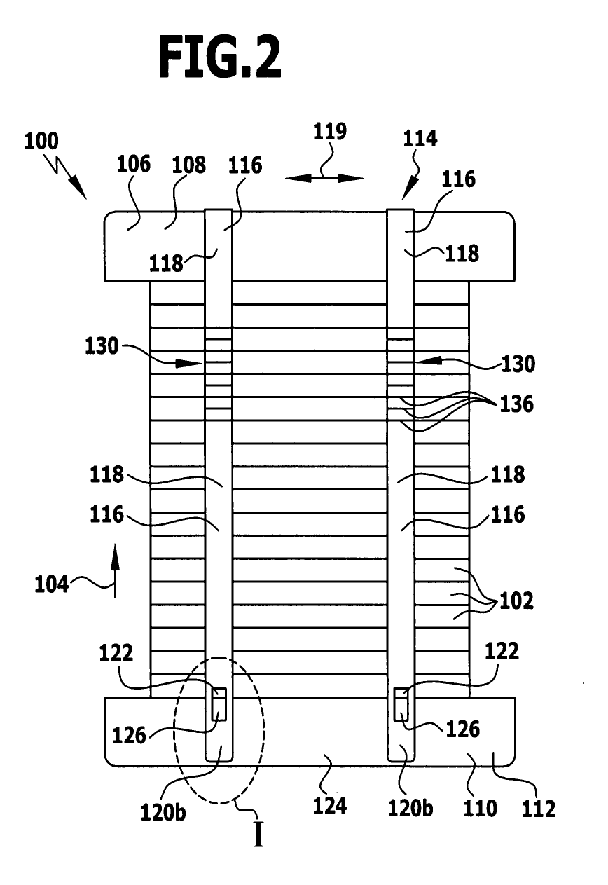

FIG. 2 a schematic side view of the fuel cell stack in FIG. 1 along the line of sight in the direction of the arrow 2 in FIG. 1;

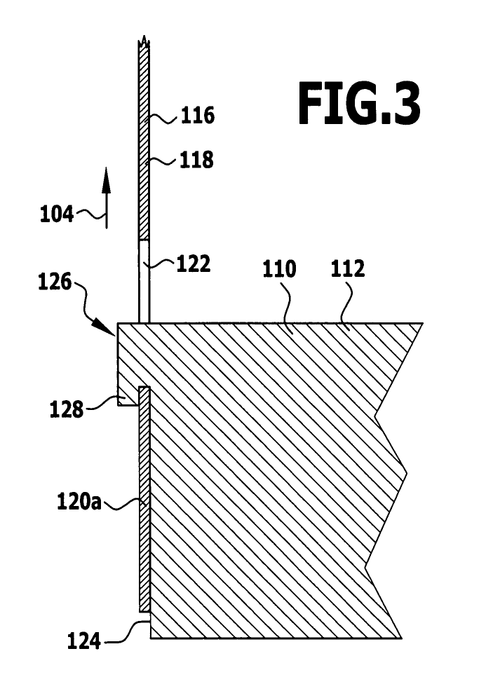

FIG. 3 a schematic vertical section through an edge region of the lower end plate of the fuel cell stack and a tensioning tape hooked onto it;

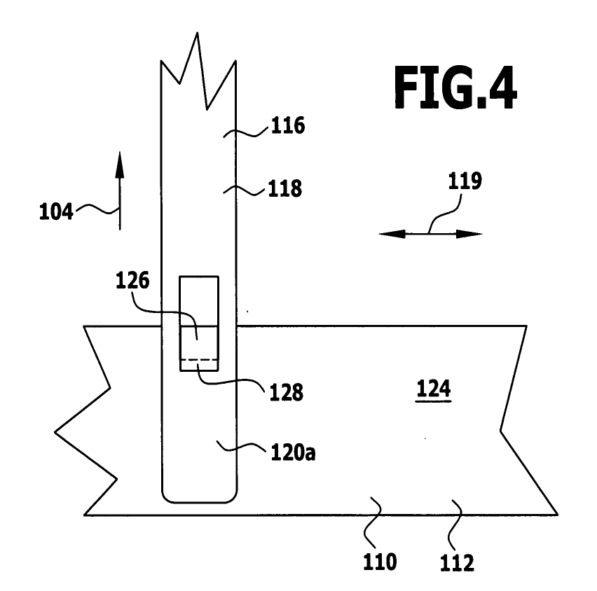

FIG. 4 an enlarged illustration of the region 1 in FIG. 2;

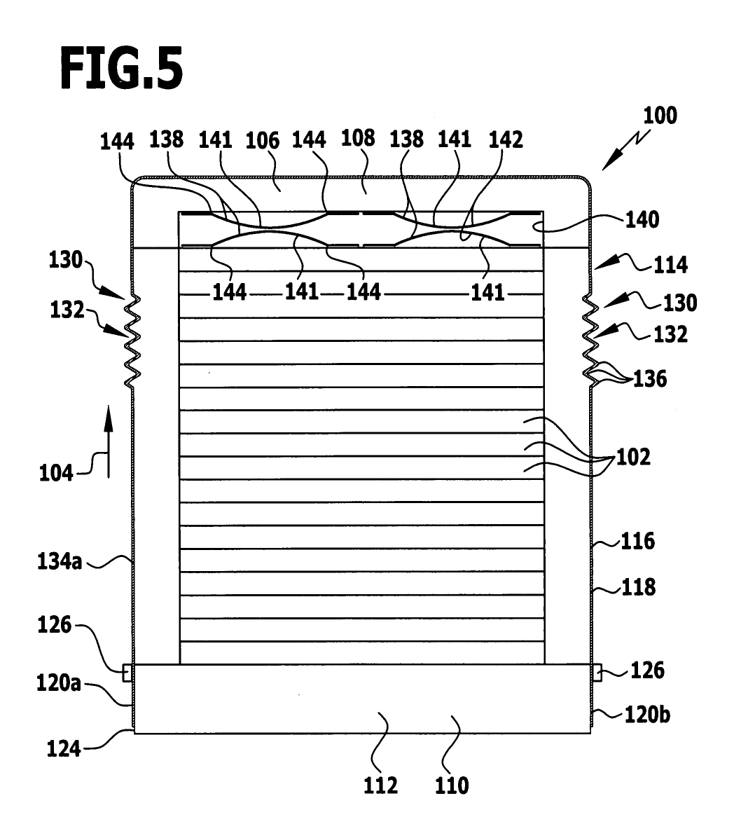

FIG. 5 a schematic front view of a second embodiment of a fuel cell stack which comprises resilient pressure transmission elements arranged between the uppermost fuel cell unit and the upper end plate;

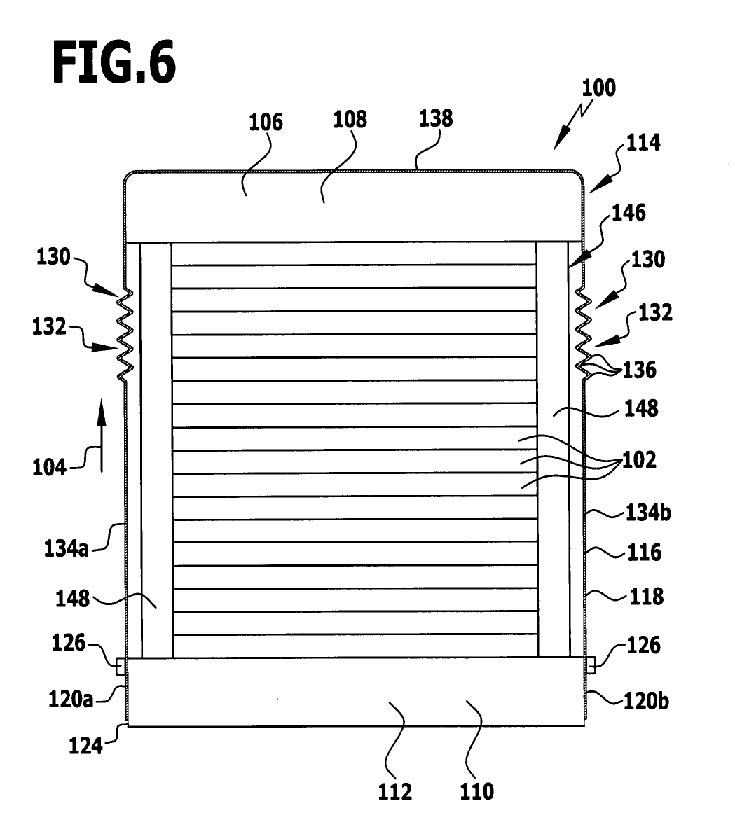

FIG. 6 a schematic front view of a third embodiment of a fuel cell stack which comprises thermal insulation elements surrounding the fuel cell units;

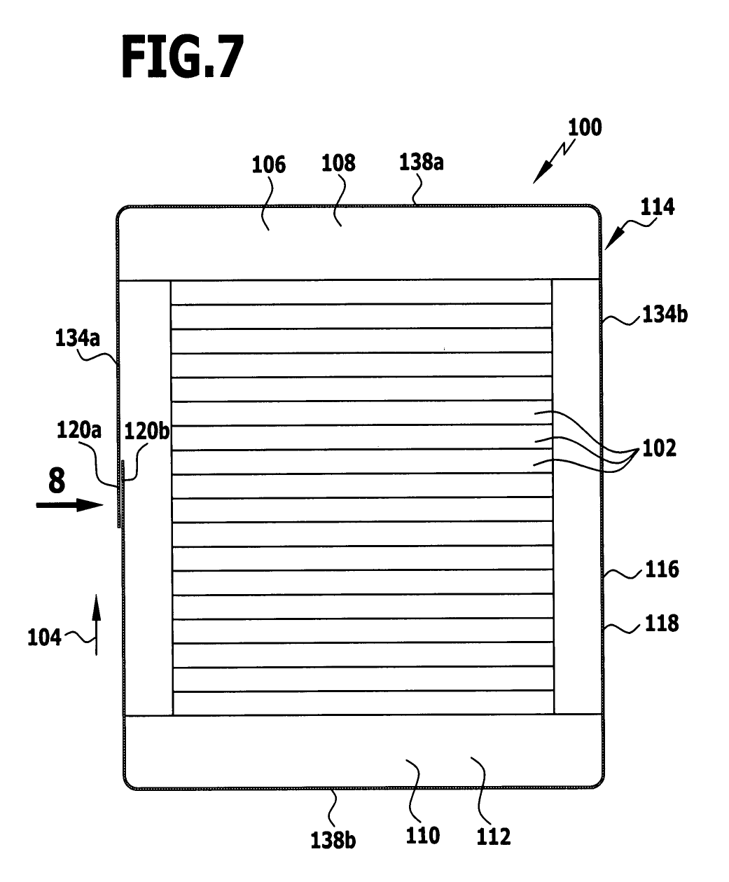

FIG. 7 a schematic front view of a fourth embodiment of a fuel cell stack which comprises two tensioning tapes that extend around the two end plates, the respective end regions of a tape being fixed together;

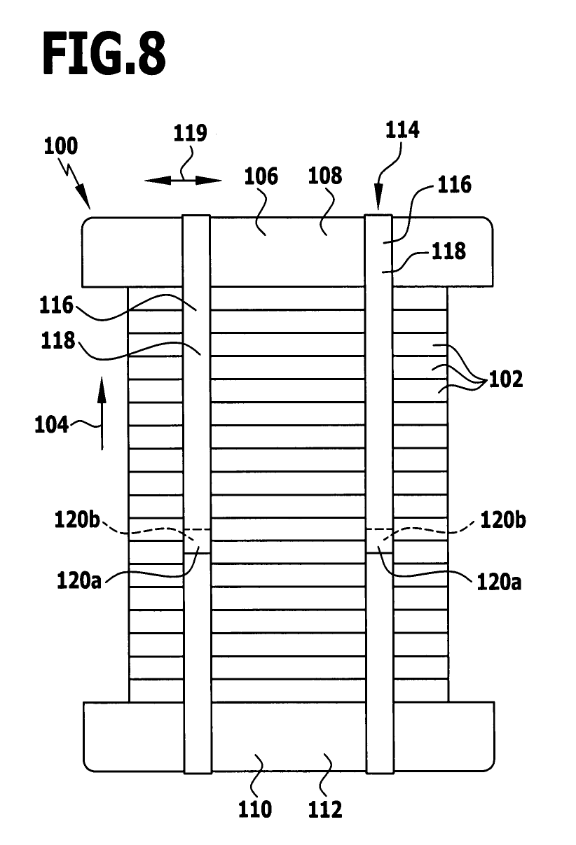

FIG. 8 a schematic side view of the fuel cell stack in FIG. 7 along the line of sight in the direction of the arrow 8 in FIG. 7;

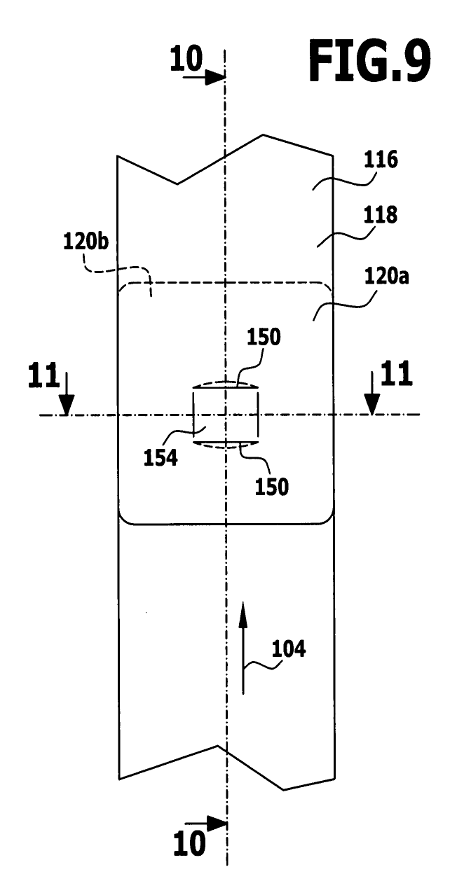

FIG. 9 a schematic plan view of the end regions of one of the tensioning tapes in FIGS. 7 and 8;

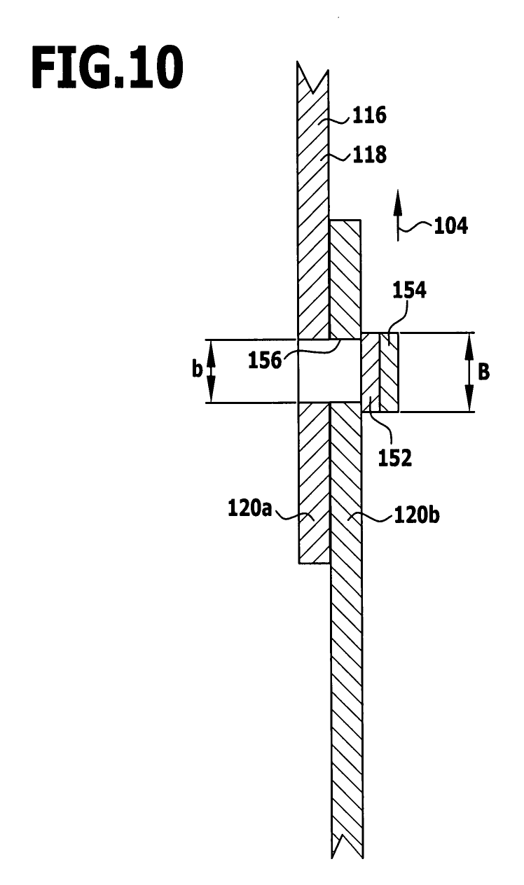

FIG. 10 a schematic vertical section through the end regions of the tensioning tape in FIG. 9 along the line 10-10 in FIG. 9;

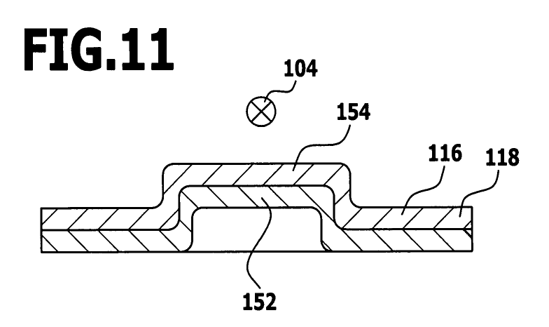

FIG. 11 a schematic horizontal section through the end regions of the tensioning tape in FIG. 9 along the line 11-11 in FIG. 9;

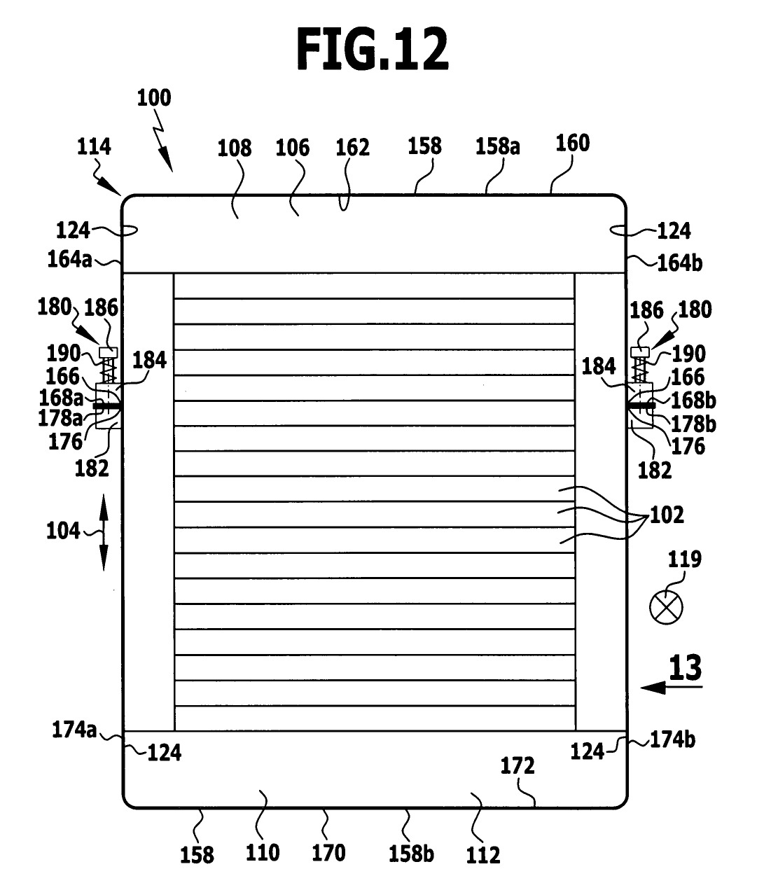

FIG. 12 a schematic front view of a fifth embodiment of a fuel cell stack which comprises two tensioning strips that extend respectively around an end plate of the fuel cell stack and are fixed together by means of a fixing device;

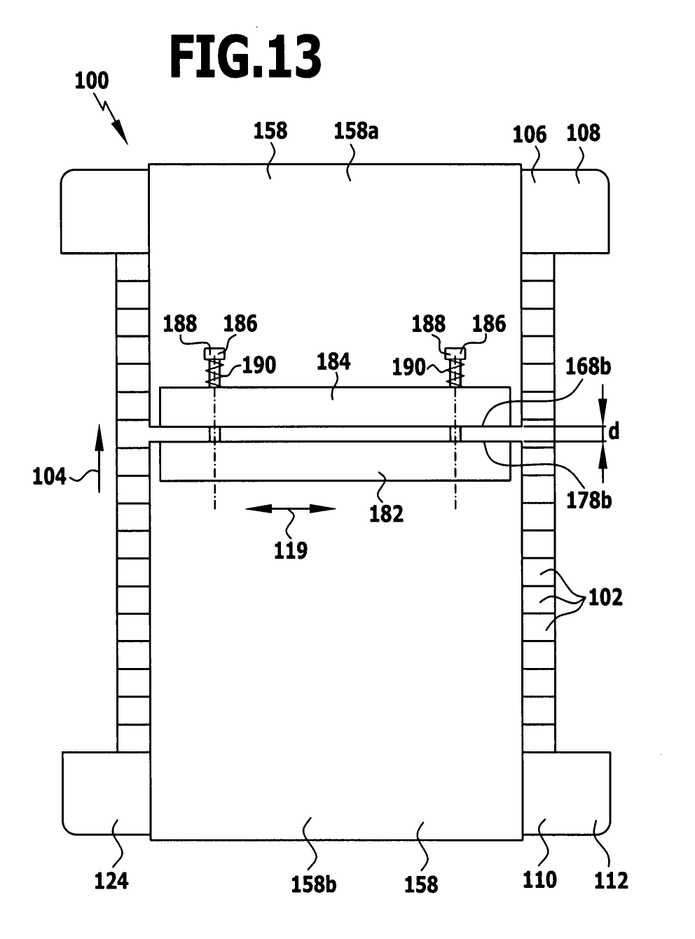

FIG. 13 a schematic side view of the fuel cell stack in FIG. 12 along the line of sight in the direction of the arrow 13 in FIG. 12;

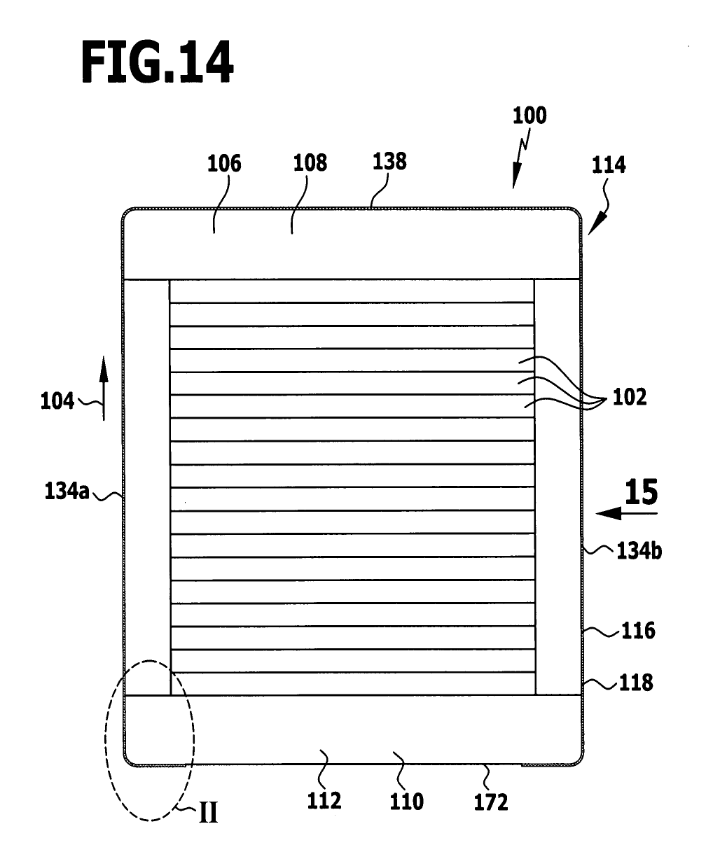

FIG. 14 a schematic front view of a sixth embodiment of a fuel cell stack which comprises two tensioning tapes that extend respectively around one end plate of the fuel cell stack and are fixed to the second end plate of the fuel cell stack;

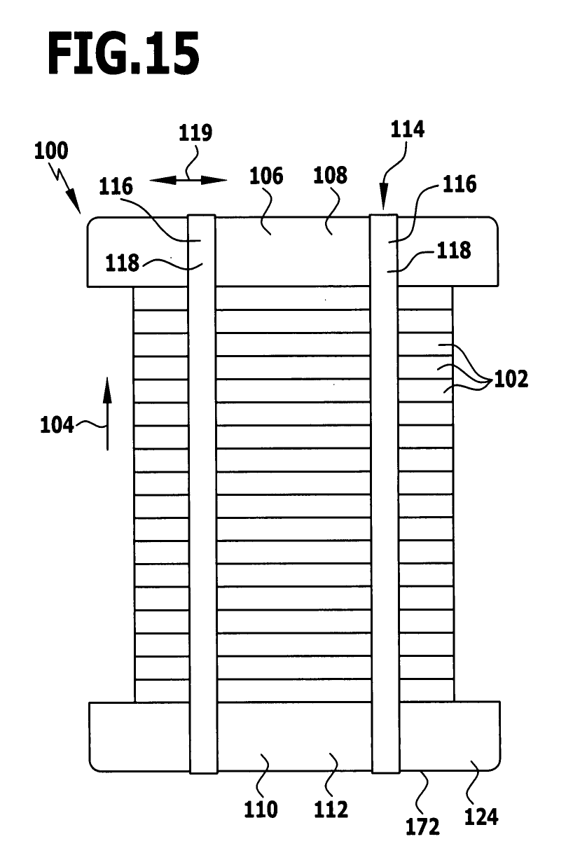

FIG. 15 a schematic side view of the fuel cell stack in FIG. 14 along the line of sight in the direction of the arrow 15 in FIG. 14;

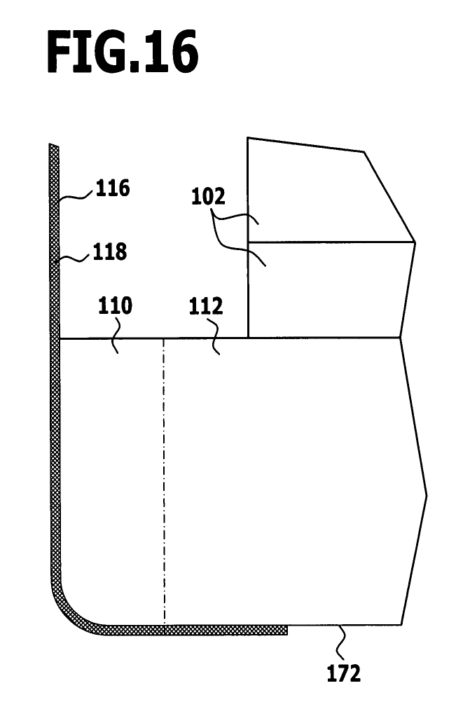

FIG. 16 an enlarged illustration of the region II in FIG. 14;

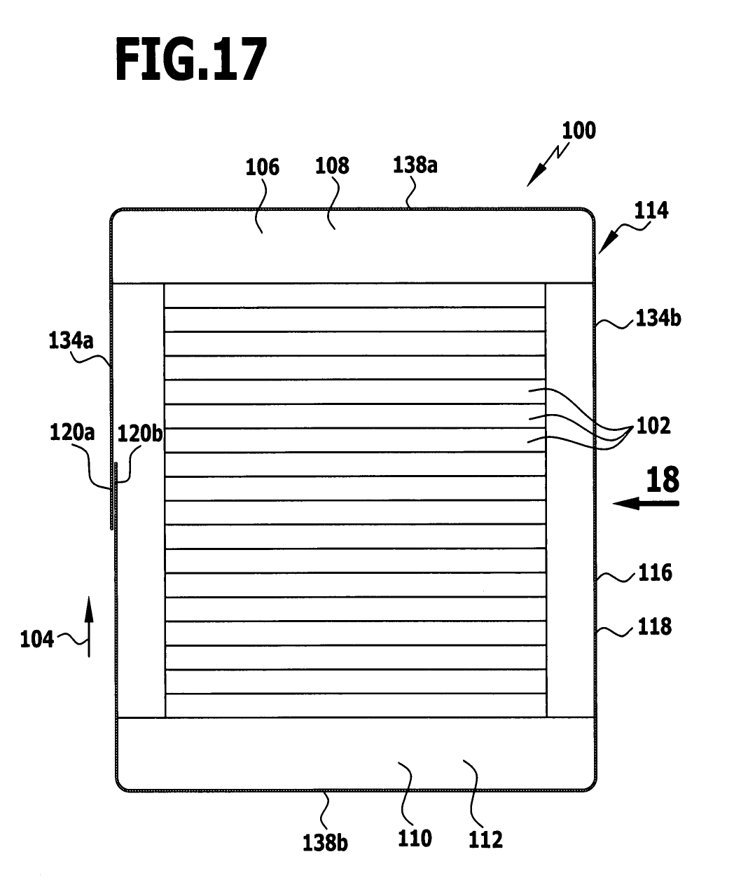

FIG. 17 a schematic front view of a seventh embodiment of a fuel cell stack which comprises two tensioning tapes that extend around both of the end plates of the fuel cell stack and are fixed to themselves at their end regions and respectively comprise a resilient longitudinal expansion compensating element in the form of a region provided with a deformable recess;

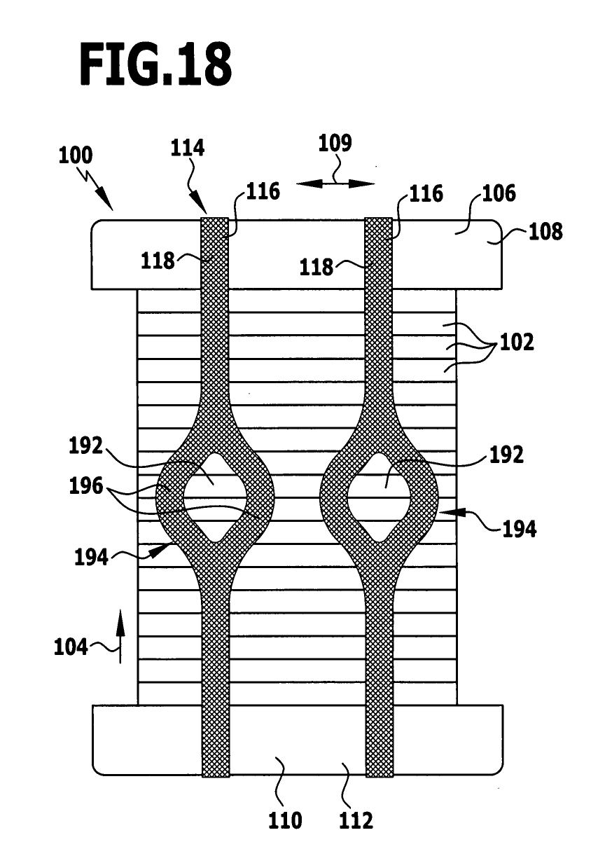

FIG. 18 a schematic side view of the fuel cell stack in FIG. 17 along the line of sight in the direction of the arrow 18 in FIG. 17;

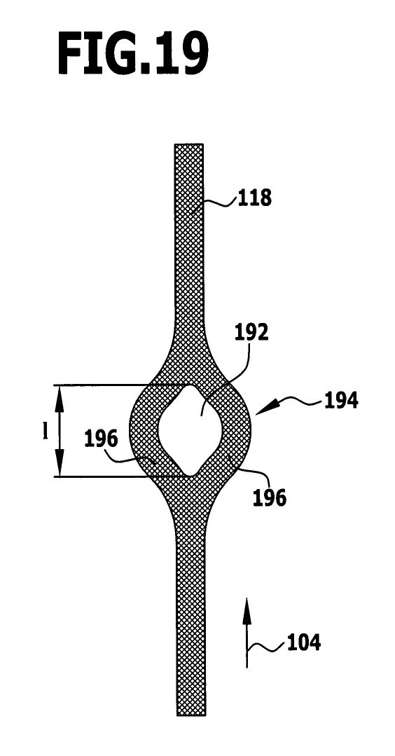

FIG. 19 a schematic plan view of the longitudinal expansion compensation region of one of the tensioning tapes in a non-stretched state; and

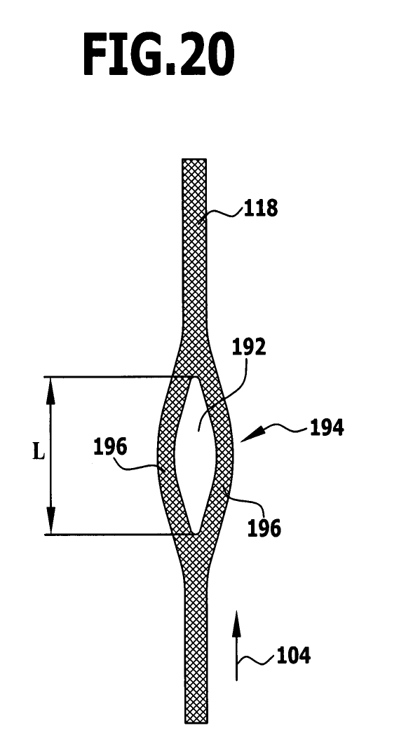

FIG. 20 a schematic plan view of the longitudinal expansion compensation region of one of the tensioning tapes in a stretched state.

Similar or functionally equivalent elements are designated by the same reference symbols in each of the Figures.

A fuel cell stack bearing the general reference 100 which is illustrated in FIGS. 1 to 4 comprises a multiplicity of planar fuel cell units 102 which are stacked on top of one another in the direction of the stack 104.

Each of the fuel cell units 102 comprises a (not illustrated in detail) housing which, for example, may be assembled from a first sheet metal shaped part in the form of an upper housing part and a second sheet metal shaped part in the form of a lower housing part such as is described and illustrated in DE 100 44 703 A1 for example.

Each of the fuel cell units 102 is provided with passage openings for a fuel gas and with passage openings for an oxidizing agent, wherein the passage openings of the successive fuel cell units 102 in the direction of the stack 104 are aligned with one another in such a manner that supply channels for the fuel gas and for the oxidizing agent as well as exhaust channels for surplus fuel gas and surplus oxidizing agent are formed through the fuel cell stack 100.

A substrate having a cathode electrolyte anode unit (CEA unit) arranged thereon is held on the housing of each fuel cell unit 102, whereby the electro-chemical fuel cell reaction takes place in the CEA unit.

The CEA units of neighbouring fuel cell units 102 are connected to one another by electrically conductive contact elements.

The housings of successive fuel cell units 102 are connected to one another by means of electrically insulating, gas-tight seal elements.

The upper end face of the fuel cell stack 100 is bounded by a first stack end element 106 in the form of an upper end plate 108.

The lower end face of the fuel cell stack 100 is bounded by a second stack end element 110 in the form of a lower end plate 112.

The end plates 108, 112 have a larger horizontal cross section than the fuel cell units 102 and project laterally beyond the stacked fuel cell units 102.

The end plates 108, 112 are preferably made of a metallic material which is chemically and mechanically stable at the operating temperature of the fuel cell units 102 and they may comprise gas passage channels that are connected to the supply channels and exhaust channels for the fuel gas and the oxidizing agent which extend through the fuel cell units 102.

Furthermore, in order to apply the requisite sealing forces to the seal elements of the fuel cell units 102 and the requisite contact forces to the contact elements of the fuel cell units 102 during operation of the fuel cell stack 100, the fuel cell stack 100 comprises a tensioning device 114 by means of which the stack end elements 106, 110 and thus the fuel cell units 102 arranged therebetween are braced against each other.

In the case of the embodiment of a fuel cell stack 100 illustrated in FIGS. 1 to 4, this tensioning device 114 comprises a plurality of, two for example, tape-like tensioning elements 116 in the form of tensioning tapes 118 which extend around one of the stack end elements 106, 110, around the upper end plate 108 for example, and the two end regions 120a, 120b thereof are hooked onto the respective other stack end element, thus, for example, on the lower end plate 112.

In order to enable this hooking process to be effected, the end regions 120a, 120b of the tensioning tapes 118 are provided with a respective, rectangular for example, hooking opening 122, whilst the side walls 124 of the lower end plate 112 are provided with a plurality of hooking noses 126 which comprise a downwardly protruding projection 128.

When hooking the tensioning tapes 118 on the fuel cell stack 100, the end regions 120a, 120b of the tensioning tapes are pulled down to such an extent that the projections 128 of the hooking noses 126 of the lower end plate 112 can be moved through the hooking openings 122 in the tensioning tapes 118 and the lower edges of the hooking openings 122 then come to rest behind the respective projections 128 forming an under-cut after they have been pulled upwardly again due to the self-elasticity of the respective tensioning tape 118 and in consequence they are prevented from being detached from the lower end plate 112 by the projections 128.

The connection between a tensioning tape 118 and the lower end plate 112 can be released in a simple manner in that the end region 120a, 120b of the tensioning tape 118 is pulled downwardly until the respective hooking opening 122 is aligned with the hooking nose 126 in such a way that the edge of the hooking opening 122 can be moved away from the side wall 124 of the lower end plate 112 past the hooking nose 126 so as to disengage the tensioning tape 118 from the hooking nose 126.

The two tensioning tapes 118 are spaced from each other in a horizontal transverse direction 119 running perpendicularly to the direction of the stack 104.

The tensioning tapes 118 are preferably formed from a metallic material, in particular, from a material consisting of a steel sheet.

As an alternative thereto, other materials having a sufficiently high tensile strength and thermal stability could also be used, such as suitable synthetic materials for example.

If the temperature of the fuel cell stack 100 changes and in particular is brought up to the operating temperature, the fuel cell units 102 together with the stack end elements 106 and 110 on the one hand and the tensioning elements 116 on the other may expand in the direction of the stack 104 by different amounts due to their different average coefficients of thermal expansion. In order to be able to compensate for such different longitudinal expansions but nevertheless produce a sufficiently high contacting force and sealing force between the fuel cell units 102 by means of the tensioning device 114, each of the tensioning elements 116 comprises two resilient longitudinal expansion compensating elements 130 which are integrated into the two sections 134a, 134b of the respective tensioning tape 118 running in parallel with the direction of the stack 104 in the form of concertina-like folded or corrugated regions 132.

If the fuel cell units 102 expand in the direction of the stack 104 to a greater extent than the material of the tensioning tapes 118, then the expansion of the folded or corrugated regions 132 in the direction of the stack 104 increases by an amount corresponding to the difference in the longitudinal expansion in that the apex lines 136 of the folded or corrugated region 132 move further apart.

Conversely, shortening of the folded or corrugated region 132 in the direction of the stack 104 is obtained by virtue of the apex lines 136 of the folded or corrugated region 132 being moved closer together.

In consequence, a difference in the thermal expansion of the fuel cell units 102 on the one hand and the material of the tensioning elements 116 on the other can be balanced out, overstretching of the tensioning elements 116 can be prevented and a desired tensioning force effective on the fuel cell units 102 can be maintained by a reversible variation in the length of the longitudinal expansion compensating elements 130.

The section 138 of each tensioning tape 118 that is arranged between the sections 134a, 134b which run parallel to the direction of the stack 104 and rest in flat manner against the side walls 124 of the upper end plate 108 is itself disposed in flat manner on the upper surface of the upper end plate 108 so that the tensional force of the tensioning elements 116 is then evenly distributed and effective over a large surface area of the upper end plate 108, this thereby ensuring a uniform flow of force through the upper end plate 108 to the fuel cell units 102

A second embodiment of a fuel cell stack 100 that is illustrated in FIG. 5 differs from the previously described first embodiment in that the first stack end element 106, i.e. the upper end plate 108, does not rest directly on the uppermost fuel cell unit 102, but rather, rests indirectly thereon via a plurality of resilient pressure transmission elements 138 which are arranged between the first stack end element 106 and the uppermost fuel cell unit 102.

For the purposes of seating these pressure transmission elements 138, the upper end plate 108 of the fuel cell stack 100 is provided on the lower surface thereof with a substantially cuboidal recess 140.

The resilient pressure transmission elements 138 may, in particular, be in the form of metal sheets which are each provided with a full corrugation 141 and are arranged on one another in pairs in such a manner that the crests 142 of the full corrugations 141 face one another and the feet 144 thereof are supported on the upper end plate 108 or on the uppermost fuel cell unit 102.

By using such additional resilient pressure transmission elements 138, the flow of force between the fuel cell units 102 on the one hand and the tensioning elements 116 and the stack end element 106 on the other can be controlled in an even more precise and equalised manner.

In all other respects, the second embodiment of a fuel cell stack 100 that is illustrated in FIG. 5 agrees in regard to the construction and functioning thereof with the first embodiment illustrated in FIGS. 1 to 4 and to this extent reference is made to the preceding description thereof.

A third embodiment of a fuel cell stack 100 that is illustrated in FIG. 6 differs from the first embodiment illustrated in FIGS. 1 to 4 in that thermal insulation 146 is arranged between the fuel cell units 102 and the tensioning device 114, this comprising end plates 108, 112 that are formed of a heat insulating material or incorporate heat insulating inserts as well as thermal insulation elements 148 laterally covering the fuel cell units 102.

The thermal insulation 146 is capable of transmitting forces from the tensioning elements 116 to the fuel cell units 102.

Furthermore, the thermal insulation 146 enables the fuel cell units 102 to be operated at an operating temperature which is significantly above the ambient temperature.

The third embodiment of a fuel cell stack 100 that is illustrated in FIG. 6 is therefore suitable, in particular, for use with high temperature fuel cell units which have an operating temperature in a range of approximately 800° C. to approximately 950° C.

Such high temperature fuel cell units may, in particular, be of the SOFC (Solid Oxide Fuel Cell) type.

In all other respects, the third embodiment of a fuel cell stack 100 that is illustrated in FIG. 6 agrees in regard to the construction and functioning thereof with the first embodiment illustrated in FIGS. 1 to 4 and to this extent reference is made to the preceding description thereof.

A fourth embodiment of a fuel cell stack 100 which is illustrated in FIGS. 7 to 11 differs from the first embodiment illustrated in FIGS. 1 to 4 in that the two tape-like tensioning elements 116 are not fixed to the lower end plate 112, but rather, they extend around both of the stack end elements 106, 110, whereby the one end region 120a of each tensioning tape 118 is connected to the other end region 120b of the same tensioning tape 118 in such a manner that each of the tensioning tapes 118 forms a closed ring-like tensioning element 116.

In particular, the connection of the two end regions 120a, 120b to one another may, as is illustrated in FIGS. 9 to 11, be effected in that a first section 152 that is separated from the remainder of the first end region 120a by two slots 150 (running perpendicularly to the direction of the stack 104 for example) and a second section 154 of the tensioning tape 118 that is substantially congruent with the first section 152 and is likewise separated from the remainder of the second end region 120b by slots running transversely to the direction of the stack 104 are respectively deformed out from the plane of the first end region 120a and that of the second end region 120b in such a way that the first section 152 passes through the passage opening 156 which ensues from the deformation of the second section 154 from the plane of the second end region.

Subsequently, the first section 152 and the second section 154 are deformed by a stamping process in such a way that the width B thereof, i.e. their elongation in the direction of the stack 104, exceeds the width b of the passage opening 156 in the second end region 120b, i.e. the elongation thereof in the direction of the stack 104, so that the first section 152 that has been pushed through the passage opening 156 can no longer be moved back through the passage opening 156 into the plane of the first end region 120a.

By fixing the two end regions 120a and 120b of each tensioning tape 118 together, the desired tensional force is produced in the tensioning tapes 118, this force being transmitted via the end plates 108, 112 to the fuel cell units 102 in order to subject them to the desired sealing forces and contact forces.

The sections 138a and 138b of each tensioning tape 118 that are arranged between the sections 134a, 134b running parallel to the direction of the stack 104 lie in flat manner on the outer surface of the upper end plate 108 or the lower end plate 112 remote from the fuel cell units 102 so as to ensure that force is applied uniformly over a large surface area to the end plates 108, 112 by the tensioning tapes 118.

The length compensating elements 130 envisaged in the first embodiment can be dispensed with in the fourth embodiment of a fuel cell stack 100 illustrated in FIGS. 7 to 11, but they may be provided however in a variant of this embodiment.

In all other respects, the fourth embodiment of a fuel cell stack 100 that is illustrated in FIGS. 7 to 11 agrees in regard to the construction and functioning thereof with the first embodiment illustrated in FIGS. 1 to 4 and to this extent reference is made to the preceding description thereof.

A fifth embodiment of a fuel cell stack 100 which is illustrated in FIGS. 12 and 13 differs from the first embodiment illustrated in FIGS. 1 to 4 in that the tensioning device 114 comprises two strip-like tensioning elements 116 in the form of tensioning strips 158 each of which is preferably a sheet metal strip rather than the tensioning tapes 118 envisaged in the first embodiment.

As can be seen from FIGS. 12 and 13, an upper tensioning strip 158a extends around the upper end plate 108 whilst a middle section 160 thereof lies in flat manner on the outer surface 162 remote from the fuel cell units 102 and the two lateral sections 164a, 164b thereof lie in flat manner on the side walls 124 of the upper end plate 108.

The lower edges of the lateral sections 164a, 164b of the tensioning strip 158 merge along a bending line 166 into a respective end region 168a, 168b of the upper tensioning strip 158a which is aligned transversely to the direction of the stack 104.

A lower tensioning strip 158b extends around the lower end plate 112 whilst a middle section 170 thereof lies in flat manner on the outer surface 172 remote from the fuel cell units 102 and the two lateral sections 174a, 174b lie in flat manner on the side walls 124 of the lower end plate 112.

The upper edges of the lateral sections 174a, 174b merge along a bending line 176 into a respective end region 178a and 178b of the lower tensioning strip 158b which is aligned transversely to the direction of the stack 104. The end regions 168a, 168b of the upper tensioning strip 158a and the end regions 178a, 178b of the lower tensioning strip 158b are fixed together by means of a respective fixing device 180 which comprises a fixing strip 182 running in the transverse direction 119 and a seating strip 184 running parallel to the fixing strip 182 and also several, two for example, fixing screw members 186 which are mutually spaced in the transverse direction 119.

The upper surface of the fixing strip 182 rests from below on the respectively associated end region 178a, 178b of the lower tensioning strip 158b, and the lower surface of the seating strip 184 rests from above on the respectively associated end region 168a, 168b of the upper tensioning strip 158a.

The fixing screw members 186 extend through passage openings in the seating strip 184 and the respective end regions 168a, 178a and 168b, 178b and are screwed into threaded blind holes which are provided in the fixing strip 182.

Between the head 188 of each fixing screw member 186 and the respectively associated seating strip 184, there is arranged a respective spring element 190 in the form of a compression spring which is supported on the head 188 and on the seating strip 184 and biases the seating strip 184 downwardly against the respectively associated end regions 168a and 168b.

In the state of the fuel cell stack 100 illustrated in FIG. 12, the mutually facing end regions 168a and 178a and also 168b and 178b of the two tensioning strips 158 rest against one another due to the bias force produced by the spring elements 190.

If, in the event of a change of temperature, the fuel cell units 102 together with the stack end elements 106 and 110 expand in the direction of the stack 104 to a greater extent than the tensioning strips 158, then the seating strips 184 of the fixing devices 180 are moved away from the fixing strips 182 in the direction of the stack 104 against the restoring force of the spring elements 190 so that the end regions 168a and 178a and also 168b and 178b are then spaced from one another by the distance d as is illustrated in FIG. 13.

The spring elements 190 of the fixing devices 180 are thus effective as longitudinal expansion compensating elements which compensate for a difference d between the thermal expansions of the fuel cell units 102 and the stack end elements 106, 110 on the one hand and the tensioning strip 158 on the other.

In all other respects, the fifth embodiment of a fuel cell stack 100 that is illustrated in FIGS. 12 and 13 agrees in regard to the construction and functioning thereof with the first embodiment illustrated in FIGS. 1 to 4 and to this extent reference is made to the preceding description thereof.

A sixth embodiment of a fuel cell stack 100 which is illustrated in FIGS. 14 to 16 differs from the first embodiment illustrated in FIGS. 1 to 4 in that the tensioning tapes 118 are not hooked onto the side walls 124 of the lower end plate 112, but rather, extend to the outer surface 172 of the lower end plate 112 remote from the fuel cell units 102 and there, they are fixed to the lower end plate 112 by an adhesive and/or a screwed connection for example.

The longitudinal expansion compensating elements 130 on the tensioning tapes 118 that were envisaged in the first embodiment can be dispensed with in this embodiment, but they may be provided however in a variant of this embodiment.

In all other respects, the embodiment of a fuel cell stack 100 that is illustrated in FIGS. 14 to 16 agrees in regard to the construction and functioning thereof with the first embodiment illustrated in FIGS. 1 to 4 and to this extent reference is made to the preceding description thereof.

A seventh embodiment of a fuel cell stack 100 that is illustrated in FIGS. 17 to 20 differs from the fourth embodiment illustrated in FIGS. 7 to 11 in that the sections 134b of the tensioning tapes 118 running in parallel with the direction of the stack 104 are provided with resilient longitudinal expansion compensating elements 130 in the form of regions 194 which are provided with a respective deformable recess 192 and are integrated into the respective tensioning tape 118.

Hereby, the deformable recesses 192 may have a substantially rhombic shape for example.

The regions 194 of the tensioning tapes 118 are greater in width than the sections of the tensioning tapes 118 located outside these regions.

The regions 194 each comprise two webs 196 which bound the respective recess and they may, for example, be of approximately the same width as the sections of the tensioning tapes 118 located outside the regions 194.

In the starting state illustrated in FIG. 19, the deformable recess 192 has an elongation I in the direction of the stack 104.

If, in the event of a change in temperature, the fuel cell units 102 together with the stack end elements 106 and 110 expand in the direction of the stack 104 to a greater extent than the material of the tensioning tapes 118, then the deformable recess 192 is stretched in the direction of the stack 104 to produce a larger elongation L, and the expansion of the region 194 in the direction of the stack 104 increases accordingly.

It is thus possible to compensate in this way for the different thermal expansions of the fuel cell units 102 and the stack end elements 106, 110 on the one hand and the material of the tensioning tapes 118 on the other.

When the temperature reverts to the starting temperature, the region 194 together with the deformable recess 192 deform back from the state illustrated in FIG. 20 into the starting state illustrated in FIG. 19 due to the self-elasticity of the tensioning tape 118 so that the desired tensional force is also maintained in the tensioning tapes 118 in the starting state illustrated in FIG. 19 and is transmitted to the fuel cell units 102 via the stack end elements 106, 110.

In all other respects, the seventh embodiment of a fuel cell stack 100 that is illustrated in FIGS. 17 to 20 agrees in regard to the construction and functioning thereof with the fourth embodiment illustrated in FIGS. 7 to 11 and to this extent reference is made to the preceding description thereof.

1. A fuel cell stack comprising a plurality of fuel cell units that succeed one another in the direction of the stack and at least one tensioning device by means of which the fuel cell units are braced against each other, wherein the tensioning device comprises at least one tensioning element in the form of a strip or tape which transmits a tensional force for the tensioning of the fuel cell units and extends around at least one end face of the fuel cell stack.

2. A fuel cell stack in accordance with claim 1, wherein the tensioning device comprises at least two tensioning elements in the form of a strip or tape which extend around at least one end face of the fuel cell stack and are mutually spaced in a direction running transverse to the direction of the stack.

3. A fuel cell stack in accordance with claim 1, wherein the fuel cell stack comprises at least one stack end element which forms an end face boundary for the fuel cell stack.

4. A fuel cell stack in accordance with claim 3, wherein at least one stack end element is in the form of an end plate.

5. A fuel cell stack in accordance with claim 3, wherein at least one tensioning element extends around at least one stack end element of the fuel cell stack.

6. A fuel cell stack in accordance with claim 5, wherein at least one tensioning element rests on least one stack end element.

7. A fuel cell stack in accordance with claim 6, wherein at least one tensioning element rests in substantially flat manner on at least one stack end element.

8. A fuel cell stack in accordance with claim 3, wherein at least one tensioning element is fixed to at least one stack end element.

9. A fuel cell stack in accordance with claim 8, wherein at least one tensioning element is fixed to at least one stack end element in cohesive manner.

10. A fuel cell stack in accordance with claim 8, wherein at least one tensioning element is fixed to at least one stack end element by means of at least one fixing means, in particular, by means of at least one screw member.

11. A fuel cell stack in accordance with claim 3, wherein at least one tensioning element is fixed to at least one stack end element in releasable manner.

12. A fuel cell stack in accordance with claim 3, wherein at least one tensioning element is hooked onto at least one stack end element.

13. A fuel cell stack in accordance with claim 12, wherein at least one stack end element comprises at least one hooking nose for the purposes of hooking the at least one tensioning element.

14. A fuel cell stack in accordance with claim 12, wherein at least one tensioning element comprises at least one hooking opening for the purposes of hooking it on at least one stack end element.

15. A fuel cell stack in accordance with claim 1, wherein at least one of the end regions of at least one tensioning element is fixed to another end region of the same tensioning element or to another tensioning element.

16. A fuel cell stack in accordance with claim 15, wherein at least one end region of at least one tensioning element is connected to another end region of the same tensioning element or to another tensioning element in positive manner.

17. A fuel cell stack in accordance with claim 15, wherein at least one section of an end region of at least one tensioning element is pushed through a passage opening in another end region of the same tensioning element or in another tensioning element and is subsequently so deformed that the pushed-through section can no longer return through the passage opening.

18. A fuel cell stack in accordance with claim 15, wherein an end region of at least one tensioning element comprises at least one passage opening and wherein a section of another end region of the same tensioning element or a section of another tensioning element is pushed through this passage opening and is subsequently so deformed that the pushed-through section can no longer return through the passage opening.

19. A fuel cell stack in accordance with claim 15, wherein at least one end region of at least one tensioning element is fixed to another end region of the same tensioning element or to another tensioning element by means of a fixing device.

20. A fuel cell stack in accordance with claim 19, wherein the fixing device comprises at least one fixing means.

21. A fuel cell stack in accordance with claim 20, wherein the fixing device comprises at least two mutually spaced fixing means running in a direction transverse to the direction of the stack.

22. A fuel cell stack in accordance with claim 20, wherein at least one fixing means is in the form of a fixing screw member.

23. A fuel cell stack in accordance with claim 19, wherein the fixing device comprises at least one fixing strip in which at least one fixing means engages.

24. A fuel cell stack in accordance with claim 19, wherein the fixing device comprises at least one seating strip through which at least one fixing means extends.

25. A fuel cell stack in accordance with claim 19, wherein the fixing device comprises at least one spring element which biases an end region of at least one tensioning element against another end region of the same tensioning element or against an end region of another tensioning element.

26. A fuel cell stack in accordance with claim 1, wherein the tensioning device comprises at least one resilient longitudinal expansion compensating element.

27. A fuel cell stack in accordance with claim 26, wherein at least one longitudinal expansion compensating element is integrated into at least one tensioning element.

28. A fuel cell stack in accordance with claim 27, wherein at least one longitudinal expansion compensating element is formed by a corrugated and/or folded region of at least one tensioning element

29. A fuel cell stack in accordance with claim 27, wherein at least one longitudinal expansion compensating element is formed by a region of at least one tensioning element that is provided with a deformable recess.

30. A fuel cell stack in accordance with claim 1, wherein the fuel cell stack comprises at least one resilient pressure transmission element.

31. A fuel cell stack in accordance with claim 30, wherein at least one pressure transmission element is arranged between a fuel cell unit and a stack end element which forms an end face boundary for the fuel cell stack.

32. A fuel cell stack in accordance with claim 1, wherein the fuel cell stack comprises at least one thermal insulation element.

33. A fuel cell stack in accordance with claim 32, wherein at least one thermal insulation element is arranged between the fuel cell units and at least one tensioning element.

34. A fuel cell stack in accordance with claim 1, wherein the tensioning device comprises at least one tensioning element in the form of a strip or tape which extends around the two end faces of the fuel cell stack.
